(19) United States
(12) Patent Application Publication
(10) Pub. No.: US 2017/0361388 A1
(43) Pub. Date: Dec. 21, 2017

(54) Method for Manufacturing a Continuous Drill Ring for a Core Drill Bit

(71) Applicant: Hilti Aktiengesellschaft, Schaan (LI)

(72) Inventors: Matthias Mueller, Buchs (CH); Marcel Sonderegger, Balgach (CH)

(73) Assignee: Hilti Aktiengesellschaft, Schaan (LI)

(21) Appl. No.: 15/538,591

(22) PCT Filed: Dec. 22, 2015
(86) PCT No.: PCT/EP2015/080900

§ 371 Date: Jun. 21, 2017

(30) Foreign Application Priority Data
Dec. 22, 2014 (EP) 14199718.9

(51) Int. Cl. B23D 65/02; B23D 61/02; B28D 1/14; B22F 7/06; B23P 15/32; B28D 1/04; B28D 1/12; C22C 26/00; B22F 5/00

(52) U.S. Cl. CPC B23D 65/02; B28D 1/041; B23D 61/025; B28D 1/146; B28D 1/121; B22F 7/06; B23P 15/32; B22F 2005/001; C22C 2026/006

(57) ABSTRACT

A method for manufacturing a continuous drill ring for a core drill bit is disclosed. The method includes forming at least two green compacts in layers in a direction of formation between a bottom side and a top side by successively applying powder layers containing a powder mixture and diamond layers containing diamond particles that are arranged in a set pattern. The green compacts are shaped into ring segments under the effect of pressure. The ring segments are joined in a circular manner and they are sintered under the effect of heat so as to obtain a continuous drill ring.

This application claims the priority of International Application No. PCT/EP2015/080900, filed Dec. 22, 2015, and European Patent Document No. 14199718.9, filed Dec. 22, 2014, the disclosures of which are expressly incorporated by reference herein.

### BACKGROUND AND SUMMARY OF THE INVENTION

The present invention relates to a method for manufacturing a continuous drill ring for a core drill bit.

In the case of diamond tools, which are designed as core drill bits, a distinction is made between core drill bits with a continuous drill ring and segmented core drill bits with individual cutting segments. Core drill bits consist of a processing segment, a cylindrical drill shaft and a receiving segment with an insertion end. The core drill bit is fastened to the tool holder of a core drill by means of the insertion end and is driven by the core drilling device about a rotational axis during drilling operation.

Continuous drill rings are produced from a powder mixture with statistically distributed diamond particles. The powder mixture is filled into a tool mold and pressed into a green part; the green part is sintered under temperature and pressure action to form a continuous drill ring. U.S. Pat. No. 5,316,416 discloses the construction of continuous drill rings which have good ablation properties over the entire height of the drill ring. The drill rings have a plurality of upper slots and lower slots distributed along the circumferential direction of the drill rings. The upper slots extend over half the height of the drill rings and open into the processing surface of the drill rings facing away from the drill shaft. The lower slots are arranged along the circumferential direction of the drill rings between the upper slots and open into the attachment surface of the drill rings facing the drill shaft. The upper and lower slots overlap at the height of the drill rings. By distribution of the upper and lower slots over the entire height of the drilling rings, a cooling and rinsing liquid is transported to the processing site over the entire operating time of the drill ring, and removed material is removed from the drilling area.

In the production of cutting segments for segmented core drill bits, in the professional sector a method has been established, in which the diamond particles are arranged in a predetermined setting pattern.

A green part is built up layer by layer from powder coatings containing a powder mixture and diamond layers with diamond particles arranged in a setting pattern and then sintered under temperature and pressure action to the cutting segment. The cutting segments are arranged along a circumferential direction of the cylindrical drill shaft and welded, soldered and otherwise fixed to the drill shaft. The cutting speed which can be achieved with a segmented core drill bit depends essentially on the arrangement of the diamonds in the cutting segment. In the layered construction, the arrangement of the diamond particles can be influenced by the number of diamond layers, the distance between the diamond layers and the size of the diamond particles.

The object of the present invention is to apply the technology of the set diamond particles to open drill rings and to increase the processing quality which can be achieved with the thus produced drill rings.

The method according to the invention for producing a continuous drill ring comprises the steps:
at least two green parts are arranged in a built-up direction by successive applications of powder layers of a powder mixture and diamond layers with diamond particles arranged in a set pattern built up between a bottom side and a top side,
the green parts are formed into ring segments under pressure action, and
the ring segments are annularly assembled and sintered under temperature action to form a continuous drill ring.

The method according to the invention comprises three process segments using different technologies. In the first process segment, several green parts are built up layer-wise from powder coatings which contain a powder mixture and diamond layers with diamond particles. The term “powder mixture” is used to summarize fine-grained powder mixtures and granulated powder mixtures; the use of granulated powder mixtures is a prerequisite for volumetric cold pressing.

As a powder mixture, iron, cobalt and/or bronze powder can be used; by adding additives such as tungsten carbide, the properties of the drill rings (wear resistance, service life, cutting ability) can be influenced. In addition, the composition of the powder mixture has an influence on the sintering temperature. The term “diamond particles” encompasses individual diamond particles as well as enveloped or coated diamond particles.

The green parts have the geometric form of a straight prism with a polygonal base surface. The prism-shaped green parts are formed into ring segments in the second process segment under pressure. The shaping of the green parts takes place at temperatures below the melting temperature of the powder mixture. In the third process segment, the ring segments are annularly assembled and sintered under temperature action to form a continuous drill ring. In the sintering of the ring segments, on the one hand, a compression of the individual ring segments takes place and on the other hand a connection between adjacent ring segments.

Cold forming, hot pressing and comparable processes are suitable as forming processes. During cold pressing, a green part is brought into the predetermined shape under high pressure. In a cold press, the material did heat up, although the forming takes place in a temperature range in which no recrystallization occurs; the material deforms without the strength significantly decreasing. In hot pressing, which is also referred to as drop forging, a green part is brought into its final shape under high pressure and the addition of heat. In addition to the shape, the forging section changes its material structure; it becomes stronger and thus obtains a denser structure and a homogeneous surface.

Sintering is a process for the production of materials in which a powder or a green part (pressed powder) is heated to temperatures below the melting temperature in order to increase the strength by joining the individual powder particles. The sintering process takes place in three stages in which the porosity and the volume of the green part are markedly reduced. In the first stage of the sintering, only the densification of the green part takes place, while in the second stage the open porosity is markedly reduced. The strength of the sintered bodies is based on the sintered compounds formed in the third stage (fusions between the powder particles), which are caused by surface diffusion between the powder particles. Hot pressing is a special sintering process in which external pressure is applied in addition to temperature.

In the method according to the invention, the drill ring is not constructed as a continuous drill ring, but is composed of two or more ring segments, which are joined by sintering.

In the construction of the green parts by layers, the known technologies are used in the production of cutting segments for segmented core drill bits.

In a preferred variant of the method, the drill ring is constructed from a number of n, n≧1 first green parts which are formed into first ring segments, and n second green parts which are formed into second ring segments, the first and second ring segments being arranged along a circumferential direction of the first ring segment of the drill ring alternately one behind the other. The production of the drill ring from first and second green parts allows the drill ring to be adapted to different substrates to be processed. In the case of core drilling in concrete materials with embedded rebar, which are also referred to as reinforced concrete materials, a drill ring encounters, for example, different substrates in the form of concrete and rebar.

Particularly preferably, the first ring segments are constructed from a first powder mixture and first diamond particles, and the second ring segments are constructed from a second powder mixture and second diamond particles. The adaptation of the drill ring to the substrate to be treated can be carried out by selecting the powder mixture and selecting the diamond particles. In the case of the powder mixture, the composition of the materials can be varied; in the case of the diamond particles, the average diamond diameter, the diamond distribution and the number of the diamond particles can be varied.

In an alternative preferred variant of the method, the drill ring is constructed from a number of 2n, n≧1 equal green parts, wherein n green parts are formed under pressure action with a convex curvature to form first ring segments and n green parts are formed under pressure action with a concave curvature to form second ring segments. The use of the same green parts can reduce the complexity of the apparatus during the layered construction of the green parts; only one powder mixture and one variety of diamond particles are required.

Particularly preferably, the upper side of the green parts is arranged on the outer side in the case of the first ring segments and on the inner side in the case of the second ring sections, wherein the first and second ring segments are arranged alternately one behind the other in a circumferential direction of the drill ring. Due to the different curvature of the ring segments, two different ring segments can be produced from the same green parts. The green parts have a diamond layer on the upper side which is arranged on the outer circumferential surface in the case of the first ring segments and on the inner circumferential surface in the case of the second ring segments.

Particularly preferably, the number of diamond layers and the size of the diamond particles are set such that the average diamond diameter of the diamond particles is at least 45% of the quotient of the drill ring width and the number of diamond layers. For the processing of reinforced concrete materials, it has proven to be advantageous if the circular ablation tracks which the diamond particles describe during processing are as close as possible to one another and the rebar is almost completely removed by the diamond particles. The number of ablation tracks which the diamond particles produce during machining can be doubled by the alternating arrangement with the same number of diamond particles.

The green parts have the geometric form of a straight prism with a polygonal base surface. The rectangular base surfaces, pentagonal base surfaces and hexagonal base surfaces are suitable as base surfaces.

In a first variant, the green parts are constructed from powder layers with rectangular base surfaces. The rectangular base is the simplest geometry for producing drill rings from multiple ring segments. The ring segments are joined to the adjacent ring segments at the side edges.

In a second variant, the green parts are constructed from powder layers with pentagonal bases, the base surfaces having a rectangle and a trapezoid with two right interior angles. In the region of the inclined trapezoidal limb, a water slot is produced during sintering with the adjacent ring segment. With such a pentagonal base surface, a number of n water slots are produced in a drill ring with 2n, n≧1 ring segments.

In a third variant, the green parts are constructed from powder layers with hexagonal base surfaces, the base surfaces having a rectangle and an isosceles trapezoid. In the region of the inclined legs of the trapezoid, water slots are produced during sintering with the adjacent ring segments. With such a hexagonal base surface, a number of n water slots are generated in a drill ring with n, n≧2 ring segments.

More preferably, the height of the trapezoid is set between ⅓ and ⅚ of the total height of the green part. For drill rings that are welded to the drill shaft, the attachment area is constructed without diamonds and is unsuitable for processing. The matrix zone, which is provided with diamond particles and is approximately ⅚ of the total height of the green part, is suitable for processing of the substrates. Particularly preferably, the height of the trapezoid is set to ⅔ of the total height of the green part. With a share of ⅔ of the total height, a sufficient strength of the finished drill ring can be ensured. During processing with the drill ring, cooling liquid must be transported to the processing site; therefore the water slots in the drill ring are designed to be as long as possible.

In a preferred further development, the ring segments are subjected to temperature and pressure action during sintering. In sintering processes with temperature and pressure action, such as hot pressing, sintering proceeds faster and at a lower temperature than in sintering processes without pressure action, such as free sintering. Since thermal diamond damage already occurs at 600° C., a lower sintering temperature can be a qualitative advantage.

Particularly preferably, the ring segments are subjected to additional external shaping by the pressure action during sintering. Special roof shapes have proven suitable for the treatment of various substrates. These roof shapes can be produced by pressure during sintering.

Embodiments of the invention are described below with reference to the drawings. This is not intended to illustrate the exemplary embodiments to scale, but the drawings are executed schematically and/or slightly distorted. With regard to supplements to the teachings directly recognizable from the drawings, reference is made to the relevant prior art. It should be understood that various modifications and changes in the form and detail of an embodiment may be made without departing from the general idea of the invention. The features of the invention disclosed in the description, the drawings as well as the claims may be essential both individually and in any combination for the further development of the invention. Moreover, all combinations of at least two of the features disclosed in the description, the drawings and/or the claims fall within the scope of the invention. The general idea of the invention is not limited to the exact form or detail of the preferred embodiment shown and described below, or limited to an object which would be limited in comparison to the subject matter asserted in the claims. In the case of given design ranges, values within the limits mentioned are also to be disclosed as limiting values and can be used and claimed as desired. For the sake of simplicity, reference numerals are subsequently used below for identical or similar parts or parts with the same or similar function.

### BRIEF DESCRIPTION OF THE DRAWINGS

FIG. 1 illustrates a core drill bit consisting of a drill ring, a cylindrical drill shaft and a receiving segment;

FIGS. 2A-C illustrate a first embodiment of a drill ring according to the invention, which is constructed from four ring segments, in a three-dimensional representation (FIG. 2A), in a cross-section perpendicular to the cylinder axis of the drill ring (FIG. 2B) and in a detail enlargement (FIG. 2C);

FIG. 3 illustrates a second embodiment of a drill ring according to the invention, which is constructed of four ring segments with water slots;

FIGS. 4A-D show the production of the drill ring of FIG. 3 of four identical green parts with a hexagonal base surface (FIG. 4A) wherein two green parts are formed into concave first ring portions and two green parts are formed into convex second ring segments (FIG. 4B), the first and second ring segments are arranged alternately one behind the other along a circumferential direction (FIG. 4C) and combined under temperature and pressure action to form a continuous drill ring (FIG. 4D); and

FIGS. 5A-C illustrate green parts with a rectangular base surface (FIG. 5A), a pentagonal base surface (FIG. 5B) and a hexagonal base surface (FIG. 5C).

### DETAILED DESCRIPTION OF THE DRAWINGS

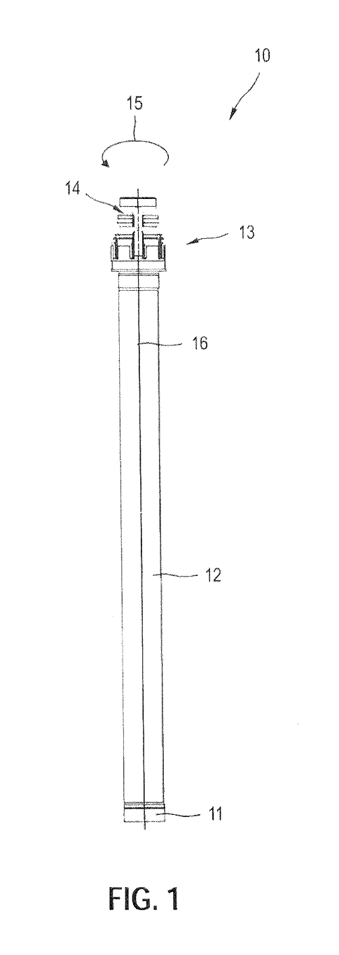

FIG. 1 shows a core drill bit 10 with a drill ring 11, a cylindrical drill shaft 12 and a receiving segment 13 with an insertion end 14. The core drill bit 10 is fastened via the insertion end 14 in the tool receptacle of a core drilling device and during drilling operation is driven by the core drilling device in a rotary direction 15 about a rotary axis 16, wherein the axis of rotation 16 is coaxial with the cylinder axis of the core drill bit 10.

The drill ring 11 is welded, brazed, or screwed to the drill shaft 12, or fixed to the drill shaft 12 in another suitable manner of attachment. In order to be able to weld the drill ring 11 with the drill shaft 12, the connecting area between the drill ring 11 and the drill shaft 12 must be made of a weldable material and must not contain diamond particle, as diamond particles cannot be welded.

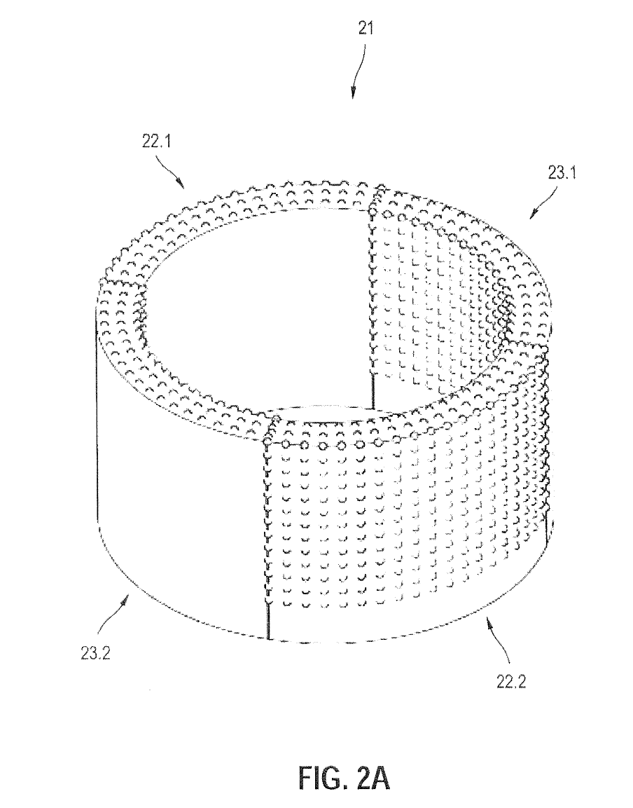

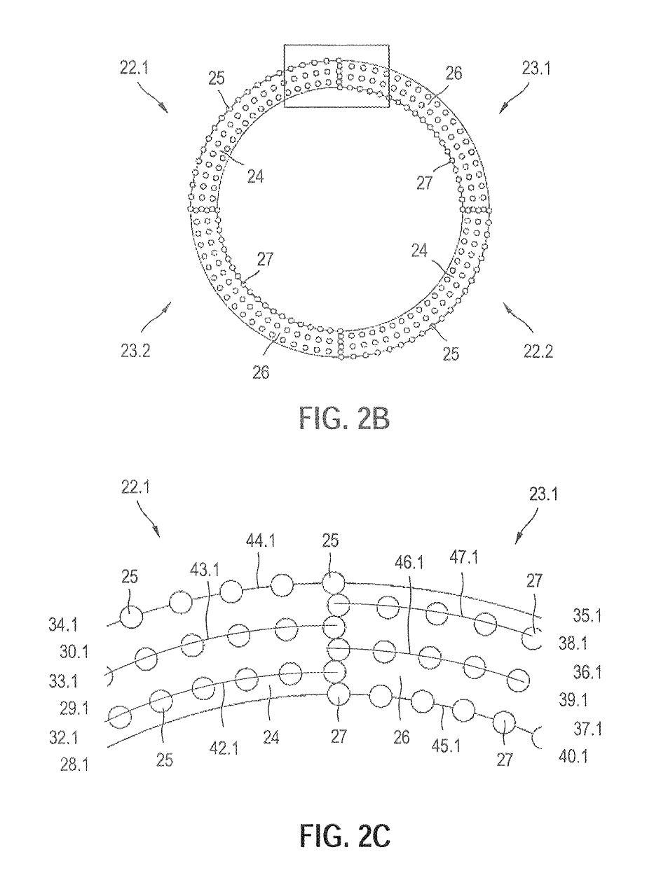

FIGS. 2A-C show a first embodiment of a drill ring 21 according to the invention, which is composed of a plurality of ring segments and which can replace the drill ring 11 of the core drill bit 10 of FIG. 1. FIG. 2A shows the drill ring 21 in a three-dimensional representation, FIG. 2B shows the drill ring 21 in a cross-section perpendicular to the axis of rotation 16, and FIG. 2C shows a detail from the cross-section of FIG. 2B in the connection area between two ring segments.

The drill ring 21 is composed of four ring segments which are connected to one another at the side edges and form a closed ring in the circumferential direction (FIG. 2A). The ring segments of the drill ring 21 can be divided into two first ring segments 22.1, 22.2 and two second ring segments 23.1, 23.2 which are arranged alternately one behind the other along the circumferential direction of the drill ring 21. The first ring segments 22.1, 22.2 consist of a first powder mixture 24 and first diamond particles 25, and the second ring segments 23.1, 23.2 consist of a second powder mixture 26 and second diamond particles 27 (FIG. 2B).

FIG. 2C shows a detail from the cross-section of FIG. 2B in the connection region between the first ring segment 22.1 and the second ring segment 23.1. The first ring segment 22.1 is constructed of a number of m₁ powder coatings of the first powder mixture 24 and m₁ of diamond layers of the first diamond particles 25. The second ring segment 23.1 is constructed of a number of m₂ powder coatings of the second powder mixture 26 and m₂ diamond layers of the second diamond particles 27. In the exemplary embodiment of FIG. 2, the first ring segment 22.1 m₁=3 powder layers 28.1, 29.1, 30.1 and m₁=3 diamond layers 32.1, 33.1, 34.1 and the second ring segment 23.1 has m₂=3 powder layers 35.1, 36.1, 37.1 and m₂=3 diamond layers 38.1, 39.1, 40.1.

The first diamond particles 25 of the diamond layers 32.1-34.1 are arranged on three circular first ablation tracks 42.1, 43.1, 44.1 with different first radii of curvature R₁ᵢ, i=1, 2, 3. The second diamond particles 27 of the diamond layers 38.1-40.1 are arranged on three circular second ablation tracks 45.1, 46.1, 47.1 with different second radii of curvature R₂ᵢ, i=1, 2, 3. The selection of the materials for the first and second powder mixtures 24, 26, the selection of the diamond distribution and size for the first and second diamond particles 25, 27, and the number m₁, m₂ of the diamond layers and the ablation tracks make it possible to adapt the drill ring 21 to different substrates to be processed.

The ring segments 22.1, 22.2, 23.1, 23.2 are constructed in layers from three powder layers and three diamond layers. In a layered configuration, the powder mixture is filled into a matrix and forms the first powder layer. The diamond particles are placed in a set pattern as a first diamond layer on the first powder layer. In order to densify the layer structure, intermediate pressing can take place after placing the diamond particles. Subsequently, the powder mixture is filled into the matrix and forms the second powder layer. The diamond particles are placed in a set pattern as a second diamond layer on or in the second powder layer. This process is repeated until the desired height of the green part is reached. A diamond layer is used as the last layer.

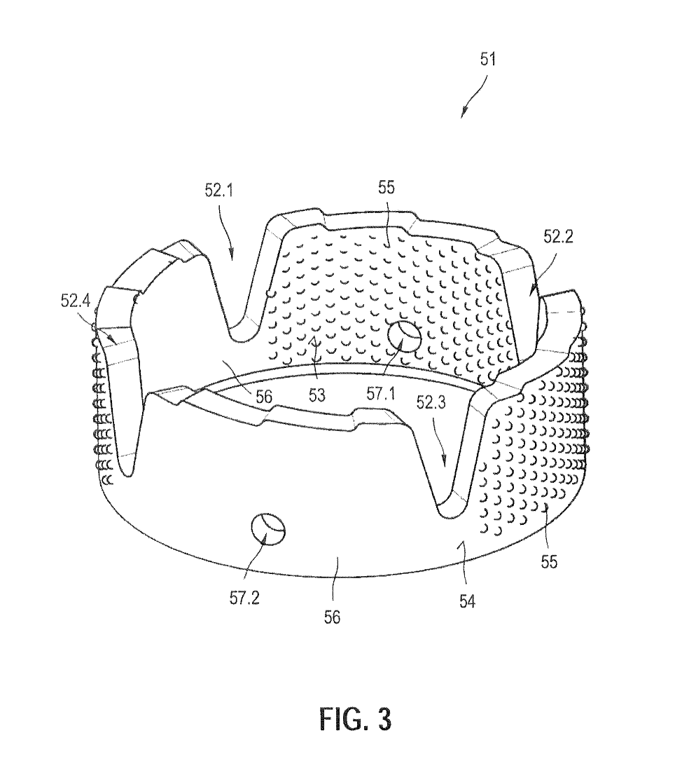

FIG. 3 shows a second embodiment of a drill ring 51 according to the invention which consists of four ring segments and can replace the drill ring 11 of the core drill bit 10. Four water slots 52.1, 52.2, 52.3, 52.4 are formed between the ring segments, via which a cooling liquid is transported to the processing site. The ring segments are arranged in such a way that the drill ring 51 alternately has a diamond-coated area 55 and a diamond-free area 56 on the inside 53 and on the outside 54.

The water slots 52.1-52.4 extend over a height of approximately ⅔ of the total height of the drill ring 51. In order to ensure the operational capability of the drill ring 51 even if the water slots 52.1-52.4 are removed, two ring segments have a bore 57.1, 57.2 via which cooling liquid is transported to the processing site.

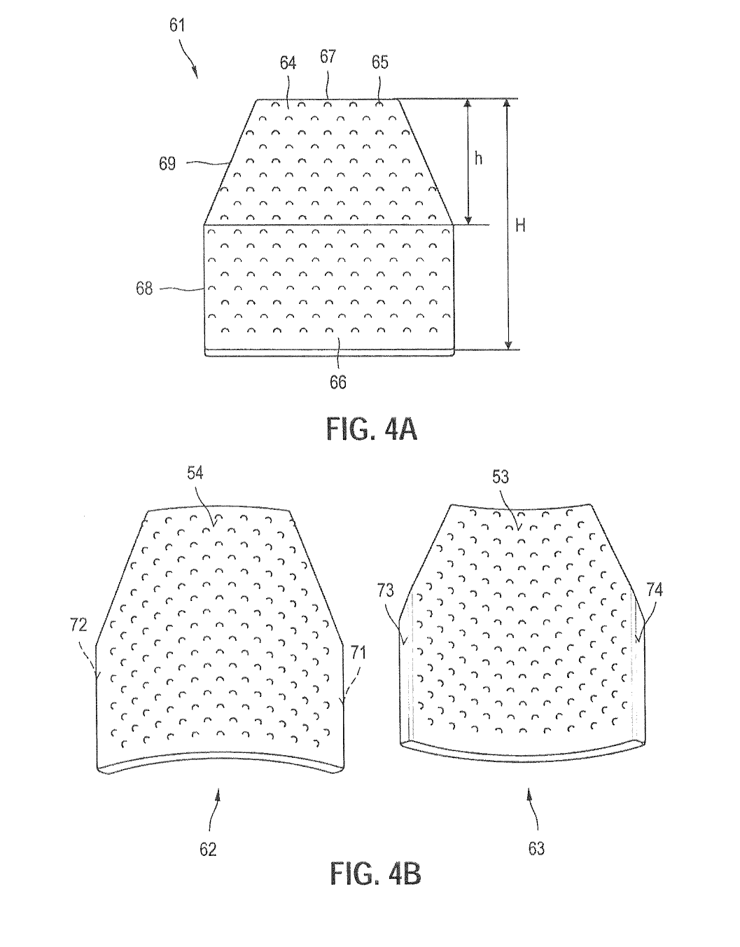

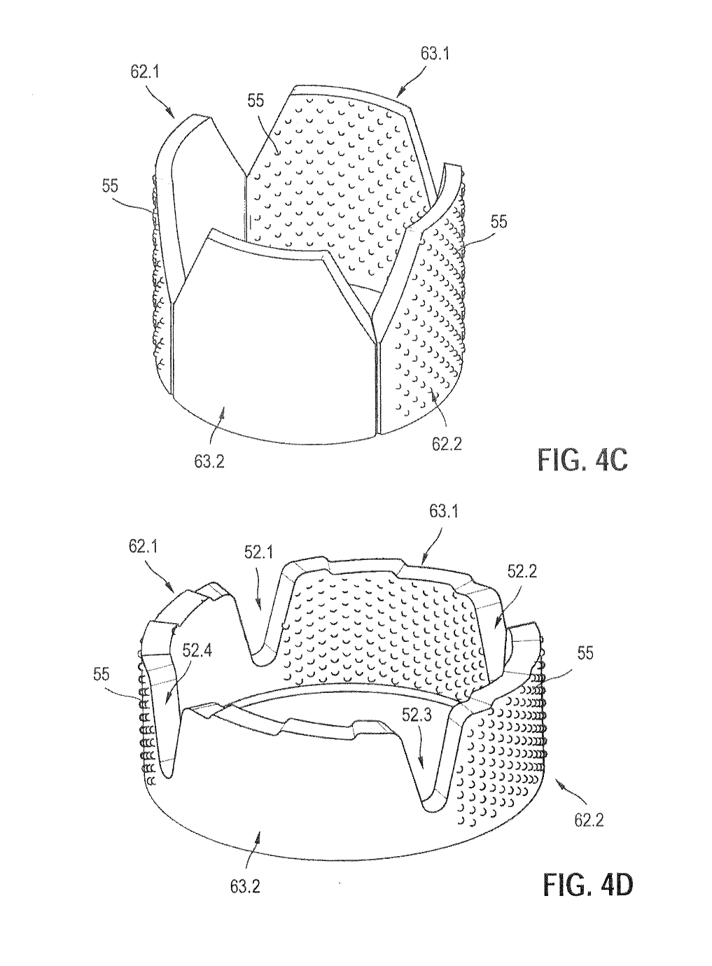

FIGS. 4A-D show the production of the drill ring 51 from four identical green parts 61 with a hexagonal base surface (FIG. 4A). Two green parts 61 are formed into concave first ring segments 62 and two green parts 61 are formed into convex second ring segments 63 (FIG. 4B). The first and second ring segments 62, 63 are arranged alternately one behind the other along a circumferential direction of the drill ring 51 (FIG. 4C) and sintered under a temperature and pressure action to form a continuous drill ring (FIG. 4D).

FIG. 4A shows the construction of the green part 61 which has been produced in powder layers from a powder mixture 64 and diamond layers of diamond particles 65. The green part 61 consists of an attachment area 66, which is also referred to as the footer zone, and a processing area 67, which is also referred to as the matrix zone. The attachment area 66 and the processing area 67 can be constructed jointly in layers, wherein no diamond particles 65 are placed in the connecting area. As an alternative, the attachment area can be produced as a separate area and can be connected to the processing area during sintering.

The base surface of the green parts 61 is hexagonal and consists of a rectangle 68 and an adjacent isosceles trapezoid 69, wherein the attachment area 66 of the green part 61 is located in the rectangle 68. In the region of the legs of the trapezoid, the water slots 52.1-52.4 are formed during sintering by additional pressure action, via which the cooling liquid is transported to the processing site. The height h of the trapezoid 69 in the green part defines the height of the water slot 52.1-52.4. In the exemplary embodiment, the height h of the trapezoid 69 corresponds to half the total height H of the green part 61.

FIG. 4B shows the first ring segment 62, which was created under pressure action with a convex curvature from the green part 61 of FIG. 4A, and the second ring segment 63, which was created under pressure action with a concave curvature from the green part 61 of FIG. 4A.

In the case of the first ring segment 62, the upper side of the green part 61, which is formed as a diamond layer, is arranged on the outer side 54, and in the second ring segment 63, the upper side of the green part 61 is arranged on the inner side 53.

The first ring segment 62 has first and second side edges 71, 72 which are joined to a first and second side edge 73, 74 of the second ring segment 63 during sintering. The first side edge 71 of the first ring segment 62 is connected to the second side edge 74 of the second ring segment 63, and the second side edge 72 of the first ring segment 62 is connected to the first side edge 73 of the second ring segment 63. In the drill ring 51 with two first and second ring segments 62.1, 62.2, 63.1, 63.2 the first and second side edges of the adjacent ring segments are connected to each other.

FIG. 4C shows the first ring segments 62.1, 62.2 and second ring segments 63.1, 63.2 arranged alternately one behind the other along a circumferential direction of the drill ring 51. The ring segments 62.1, 63.1, 62.2, 63.2 form a continuous drill ring and, in the embodiment shown in FIG. 4C, are processed further in a hot press. FIG. 4D shows the continuous drill ring after hot pressing. During hot pressing, the ring segments 62.1, 63.1, 62.2, 63.2 are subjected to temperature and pressure action. The temperature action ensures that the powder mixture is sintered in the ring segments and the ring segments are connected to one another at the side edges. Pressure in the axial direction, i.e., parallel to the axis of rotation of the drill ring, causes compression of the ring segments, which leads to densification of the ring segments. Hot pressing is carried out in a die which defines the final shape of the drill ring.

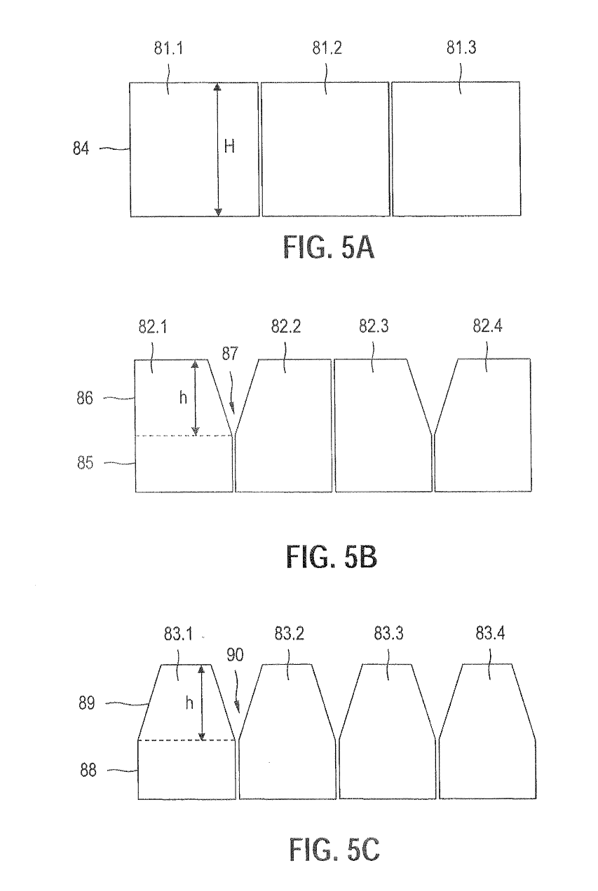

In the method according to the invention, a drill ring is constructed from a plurality of green parts, which are formed into ring segments and are sintered to form a continuous drill ring; polygonal base surfaces are a suitable geometry for the green parts. FIGS. 5A-C show green parts 81 with a rectangular base surface (FIG. 5A), green parts 82 with a pentagonal base surface (FIG. 5B) and green parts 83 with a hexagonal base surface (FIG. 5C).

The rectangular base surface 84 of the green parts 81 represents the simplest geometry for producing drill rings from a plurality of ring segments. In the exemplary embodiment of FIG. 5A, three identical green parts 81.1, 81.2, 81.3 are used to produce a continuous drill ring.

The pentagonal base surface of the green parts 82 can be divided into a rectangle 85 and a trapezoid 86 with two right interior angles. In the region of the inclined leg of the trapezoid, a water slot 87 is produced during sintering with the adjacent ring segment. A number of n water slots 87 are produced with such a pentagonal base surface for a drill ring with 2n, n≧1 ring segments.

The hexagonal base surface of the green parts 83 can be divided into a rectangle 88 and an isosceles trapezoid 89. In the region of the inclined trapezoidal legs, water slots 90 are produced during sintering with the adjacent ring segments. With such a hexagonal base surface, a number of n water slots 90 are generated in a drill ring with n, n≧2 ring segments.

1.-12. (canceled)

13. A method of manufacturing a continuous drill ring for a core drill bit, comprising the steps of:
producing at least two green parts by successive applications of powder layers of a powder mixture and diamond layers with diamond particles disposed in a set pattern;
forming the at least two green parts into respective ring segments under pressure; and
annularly assembling the ring segments and sintering the ring segments under temperature action to form the continuous drill ring.

14. The method according to claim 13, wherein the continuous drill ring includes n≧1 first green parts which are formed into first ring segments and n second green parts which are formed into second ring segments and wherein the first and the second ring segments are disposed alternately one behind the other along a circumferential direction of the continuous drill ring.

15. The method according to claim 13, wherein the continuous drill ring includes first ring segments and second ring segments, wherein the first ring segments include a first powder mixture and first diamond particles, and wherein the second ring segments include a second powder mixture and second diamond particles.

16. The method according to claim 13, wherein the continuous drill ring includes a number of 2n, n≧1 equal green parts, wherein n green parts are formed under pressure action with a convex curvature to form first ring segments and n green parts are formed under pressure action with a concave curvature to form second ring segments.

17. The method according to claim 16, wherein an upper side of the first ring segments is disposed on an outer side of the continuous drill ring and wherein an upper side of the second ring segments is disposed on an inner side of the continuous drill ring, wherein the first and the second ring segments are disposed alternately one behind the other along a circumferential direction of the continuous drill ring.

18. The method according to claim 13, wherein a number of the diamond layers and a size of the diamond particles are set such that an average diamond diameter of the diamond particles is at least 45% of a quotient of a width of the continuous drill ring and the number of the diamond layers.

19. The method according to claim 13, wherein the at least two green parts are constructed from powder layers with rectangular base surfaces.

20. The method according to claim 13, wherein the at least two green parts are constructed from powder layers with pentagonal base surfaces and wherein the pentagonal base surfaces have a rectangle and a trapezoid with two right interior angles.

21. The method according to claim 13, wherein the at least two green parts are constructed from powder layers with hexagonal base surfaces and wherein the hexagonal base surfaces have a rectangle and an isosceles trapezoid.

22. The method according to claim 20, wherein a height of the trapezoid is between ⅓ and ⅚ of a total height of the respective green part.

23. The method according to claim 13, wherein the ring segments are subjected to pressure action during the sintering.

24. The method according to claim 23, wherein the ring segments are subjected to external shaping by the pressure action during the sintering.
